(19) United States
(12) Patent Application Publication
(10) Pub. No.: US 2014/0033665 A1
(43) Pub. Date: Feb. 6, 2014

(54) MULTIPLE LAYER HEPA FILTER AND METHOD OF MANUFACTURE

(71) Applicant: General Electric Company, Schenectady, NY (US)

(72) Inventors: Alan Smithies, Overland Park, KS (US); Vishal Bansal, Overland Park, KS (US); Nusrat Farzana, Houston, TX (US); Cynthia Polizzi, Schenectady, NY (US)

(21) Appl. No.: 14/060,287

(22) Filed: Oct. 22, 2013

Related U.S. Application Data
(63) Continuation-in-part of application No. 13/014,325, filed on Jan. 26, 2011, now abandoned.

(51) Int. Cl. B01D 46/52; B01D 46/00

(52) U.S. Cl. CPC B01D 46/521; B01D 46/0001
USPC 55/486; 156/222

(57) ABSTRACT

A multiple layer HEPA filter media includes, in an exemplary embodiment, a first layer that includes a nonwoven synthetic fabric formed from a plurality of bicomponent synthetic fibers with a spunbond process, and having a bond area pattern of a plurality of substantially parallel discontinuous lines of bond area. The filter media also includes a second layer laminated onto the first layer. The second layer is formed from a micro-porous membrane. Further, the filter media includes a third layer laminated onto the second layer, with the third layer including a synthetic nonwoven fabric formed from a plurality of synthetic fibers. The synthetic fibers include at least two different synthetic fibers having different melting points. The third layer has a cover factor of less than seven millimeters. In addition, the multiple layer filter media further includes a plurality of corrugations.

### CROSS-REFERENCE TO RELATED APPLICATION

The present application is a continuation-in-part of U.S. patent application Ser. No. 13/014,325, filed 26 Jan. 2011, the disclosure of which is incorporated herein by reference.

### BACKGROUND OF THE INVENTION

The field of the invention relates generally to a filter element that may be used in pulse-jet cleaning filtration systems, and more particularly, to a filter element having a multiple layer filter media.

Fabric filtration is a common technique for separating out particulate matter in an air stream, for example, gas turbine inlet air. Filter elements include a filter media that captures particulate matter in an air stream. During use, as particulate matter accumulates or cakes on the filters, the flow rate of the air is reduced and the pressure drop across the filters increases. To restore the desired flow rate, a reverse pressure pulse is applied to the filters. The reverse pressure pulse separates the particulate matter from the filter media, which then falls to a lower portion of a dirty air plenum.

Gas turbine operators desire higher levels of filtration efficiency in their inlet filters systems without compromising performance of inlet air flow due to higher pressure drop in the filters. High pressure drop usually causes increased operating costs in terms of energy production and maintenance costs. The use of HEPA level filters in inlet filtration systems may provide better protection to turbine components which are being made from more exotic and less forgiving materials. HEPA level filters typically provide against the ingestion of particulate that can cause erosion, fouling, and corrosion of turbine components. However, HEPA level filters have an increased pressure drop at standard operating airflow rates when compared to filters with lower filtration efficiencies. Relatively higher pressure drops at the inlet of the turbine decrease the heat rate of the power plant and decrease the amount of energy able to be produced.

### BRIEF DESCRIPTION OF THE INVENTION

In one aspect, a multiple layer HEPA filter media is provided. The multiple layer filter media includes a first layer that includes a nonwoven synthetic fabric formed from a plurality of bicomponent synthetic fibers with a spunbond process, and having a bond area pattern of a plurality of substantially parallel discontinuous lines of bond area. The filter media also includes a second layer laminated onto the first layer. The second layer is formed from a micro-porous membrane. Further, the filter media includes a third layer laminated onto the second layer, with the third layer including a synthetic nonwoven fabric formed from a plurality of synthetic fibers. The synthetic fibers include at least two different synthetic fibers having different melting points. The third layer has a cover factor of less than seven millimeters (mm) In addition, the multiple layer filter media further includes a plurality of corrugations.

In another aspect, a HEPA filter element is provided. The filter element includes a first end cap, a second end cap, and a multiple layer filter media extending between the first end cap and the second end cap. The multiple layer filter media includes a first layer that includes a nonwoven synthetic fabric formed from a plurality of bicomponent synthetic fibers with a spunbond process, and having a bond area pattern of a plurality of substantially parallel discontinuous lines of bond area. The filter media also includes a second layer laminated onto the first layer. The second layer is formed from a micro-porous membrane. Further, the filter media includes a third layer laminated onto the second layer, with the third layer including a synthetic nonwoven fabric formed from a plurality of synthetic fibers. The synthetic fibers include at least two different synthetic fibers having different melting points. The third layer has a cover factor of less than seven millimeters (mm) In addition, the multiple layer filter media further includes a plurality of corrugations.

In another aspect, a method of making a multiple layer HEPA filter media is provided. The method includes forming a first layer that includes a spunbond nonwoven fabric substrate having a plurality of bicomponent synthetic fibers, calendering the nonwoven fabric substrate with embossing calender rolls to form a bond area pattern having a plurality of substantially parallel discontinuous lines of bond area to bond the synthetic bicomponent fibers together to form a nonwoven fabric. The method also includes laminating a first side of a second layer to a surface of the first layer, where the second layer includes a micro-porous membrane. The method further includes laminating a third layer to a second side of the second layer, with the third layer including a synthetic nonwoven fabric formed from a plurality of synthetic fibers. The synthetic fibers include at least two different synthetic fibers having different melting points. The third layer has a thickness of less than 0.076 mm, and a cover factor of less than seven millimeters (mm) In addition, the method includes corrugating the composite filter media, and pleating the composite filter media.

### BRIEF DESCRIPTION OF THE DRAWINGS

FIG. 1 is cross sectional illustration of an exemplary aspect of a filter media.

FIG. 2 is a photomicrograph of bicomponent fibers used in the first layer of filter media shown in FIG. 1.

FIG. 3 is a photomicrograph of the first layer of filter media shown in FIG. 1.

FIG. 4 is a top illustration of the bond pattern of the first layer of the filter media shown in FIG. 1.

FIG. 5 is an enlarged schematic plan view of a portion of the second layer of the filter media shown in FIG. 1.

FIG. 6 is a graph of pressure drop versus time of a filter cartridge in accordance with an exemplary embodiment compared to a comparison filter element.

FIG. 7 is cross sectional illustration of an exemplary aspect of the filter media shown in FIG. 1 after corrugating.

FIG. 8 is a side illustration of a filter cartridge that includes the filter media shown in FIG. 1.

FIG. 9 is an enlarged perspective illustration of a portion of the filter cartridge shown in FIG. 8.

FIG. 10 is a perspective illustration of a filter assembly that includes the filter cartridge shown in FIG. 8.

### DETAILED DESCRIPTION OF THE INVENTION

A filter element, a multiple layer filter media, and a method of making the multiple layer filter media are described in detail below. The filter media, in an exemplary embodiment, includes three layers. The first layer provides support for the other layers, and is a nonwoven fabric substrate made from a plurality of bicomponent synthetic fibers. The second layer is a micro-porous membrane, for example, expanded polytetrafluoroethylene (ePTFE), and the third layer is a synthetic nonwoven fabric formed from a plurality of synthetic fibers. The synthetic fibers include at least two different synthetic fibers having different melting points. In one embodiment, the third layer has thickness of less than 0.08 mm, and a cover factor of less than 7 mm. The filter element has a HEPA filtration efficiency level without incurring relatively high pressure drop over time. In one embodiment, the filter element attains an H-12 efficiency rating, and in other embodiments, the filter element may have an efficiency rating of an H-11 and H-10. The filter element may be used in pulse-jet cleaning filtration systems, and provide higher filtration than known filter elements. For example, when used as an inlet filter of a gas turbine, the filter element provides high filtration efficiency (H-12) without causing high pressure drops to maintain performance of the gas turbine. The high efficiency of the filter element reduces the amount of particulates that reaches the gas turbine blades which lengthens the life of the turbine blades and reduces maintenance that reduces operating costs.

By “cover factor” is meant the parameter defined by the equation: cover factor (mm)=media void volume ((1−media density in g/cc) (%))×media thickness (mm) The cover factor is applicable for materials with an air permeability of greater than 400 cubic feet per minute (cfm).

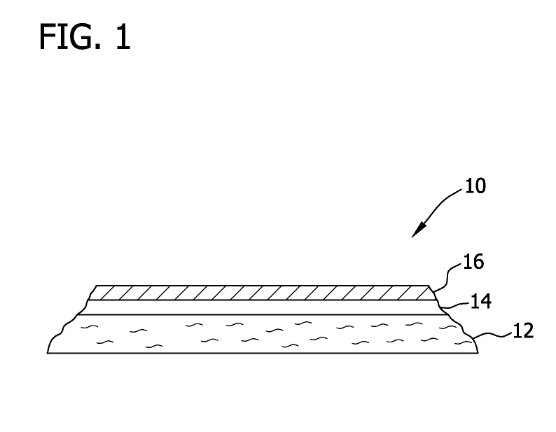

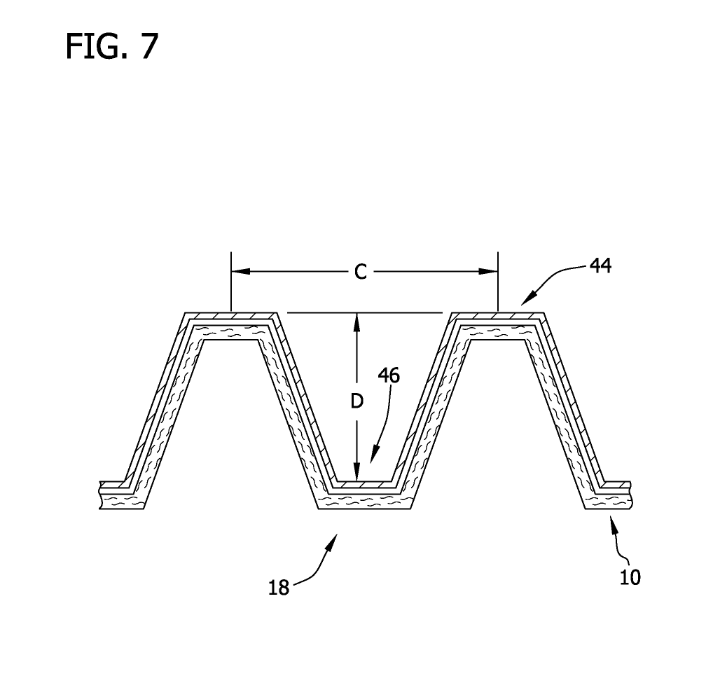

Referring to the drawings, FIG. 1 is a sectional illustration of an exemplary aspect of a multiple layer HEPA filter media 10. Filter media 10 includes a first layer 12, a second layer 14 laminated onto first layer 12, and a third layer 16 laminated onto second layer 14. A plurality of corrugations 18 (shown in FIG. 7) are formed in filter media 10.

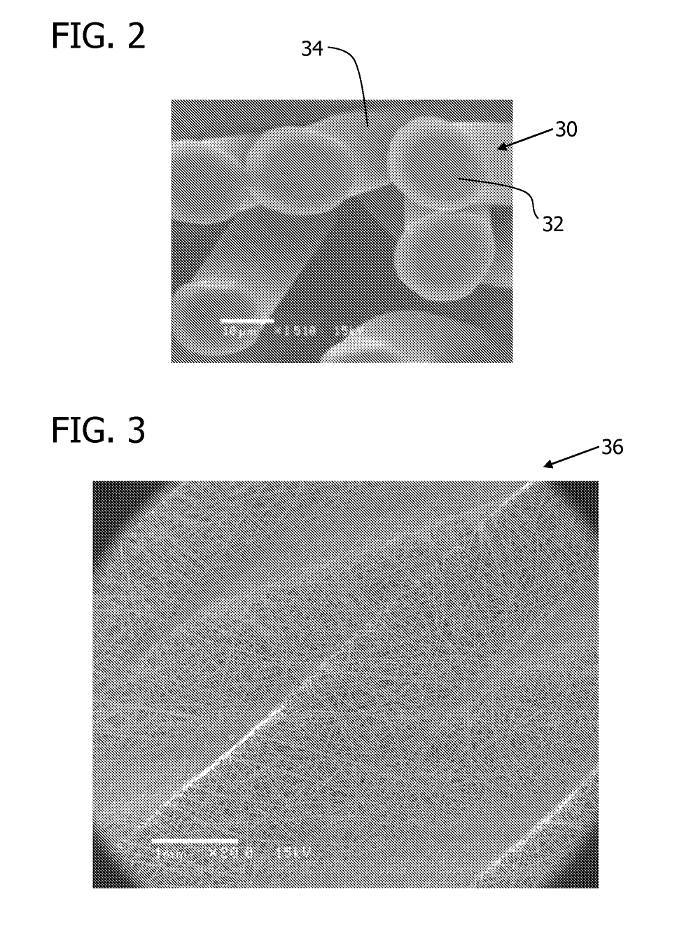

First layer 12 is a nonwoven fabric formed from synthetic bicomponent fibers using a spunbond process. Suitable bicomponent fibers are fibers having a core-sheath structure, an island structure or a side-by-side structure. Referring also to FIG. 2, in the exemplary embodiment, a bicomponent fiber 30 includes a core 32 and a sheath 34 circumferentially surrounding core 32. Bicomponent fibers 30 are meltspun through jets into a plurality of continuous fibers which are uniformly deposited into a random three dimensional web. The web is then heated and embossed calendered which thermally bonds the web into a consolidated spunbond fabric 36, as shown in FIG. 3. Heat from contact of the calender roll embossing pattern softens or melts the thermoplastic sheath 34 of bicomponent fibers 30 which binds the nonwoven fibers together only at the contact points of calender roll embossing pattern. The temperature is selected so that at least softening or fusing of the lower melting point sheath 34 portion of bicomponent fibers 30 occurs. In one embodiment, the temperature is about 90° C. to about 240° C. The desired connection of the fibers is caused by the melting and re-solidification of sheath portion 34 after cooling.

Bicomponent fibers 30 have diameters of about 12 microns to about 18 microns which is finer than the known fibers used in traditional and common spunbond products. A unique aspect of first layer 12 is the bond pattern used to consolidate spunbond first layer 12. The bond pattern is defined by the embossing pattern of the calender rolls. The bond area of the spunbond bicomponent fibers in first layer 12 is about 10 percent to about 14 percent of the total area of the fabric as compared to the bond area of about 19 to 24 percent of traditional spunbond media used in filtration. The bond area provides for media durability and function while at the same time the bond points create areas of fused polymer that have zero air flow.

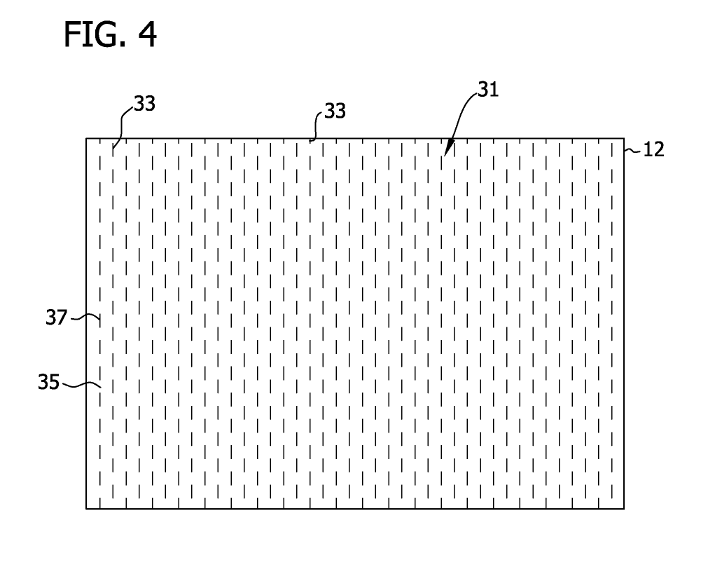

Referring also to FIG. 4, a bond pattern 31 on first layer 12 attains an acceptable durability to first layer 12, while allowing more fiber to be available for filtration thus increasing filtration efficiency. Bond pattern 31 includes a plurality of parallel discontinuous lines 33 of bond area extending across first layer 12 and in a direction parallel to the machine direction (longitudinal extent) of first layer 12. The parallel discontinuous lines 33 of bond area are off-set from each other so that at a location of no bond area 35 in a discontinuous line 33 is aligned with a bond area 37 of an adjacent discontinuous line 33. The bond area 37 of spunbond bicomponent fibers 30 in first layer 12 is about 10 percent to about 14 percent of the total area of the fabric as compared to the bond area of about 19 to 24 percent of known spunbond fabrics. The lower bond areas allow for first layer 12 to have increase air permeability or inversely low pressure drop when tested at a given air flow. In the exemplary embodiment the basis weight of first layer 12 is about 100 g/m² to about 330 g/m², in another embodiment, about 100 g/m² to about 220 g/m².

Any suitable synthetic bicomponent fiber 30 can be used to make the nonwoven fabric of first layer 12. Suitable materials for core 32 and sheath 34 of bicomponent fiber 30 include, but not limited to, polyesters, polyamides, polyolefins, thermoplastic polyurethanes, polyethylene teraphthalate (PET), polyetherimides, polyphenyl ethers, polyphenylene sulfides, polysulfone, aramid, and mixtures thereof. Suitable materials for the sheath of the bicomponent fiber include thermoplastic materials that have a lower melting point than the material of the core of the bi-component fiber, for example polyester, polyamide, polyolefin, thermoplastic polyurethane, polyetherimide, polyphenyl ether, polyphenylene sulfide, polysulfone, aramid, and mixtures thereof.

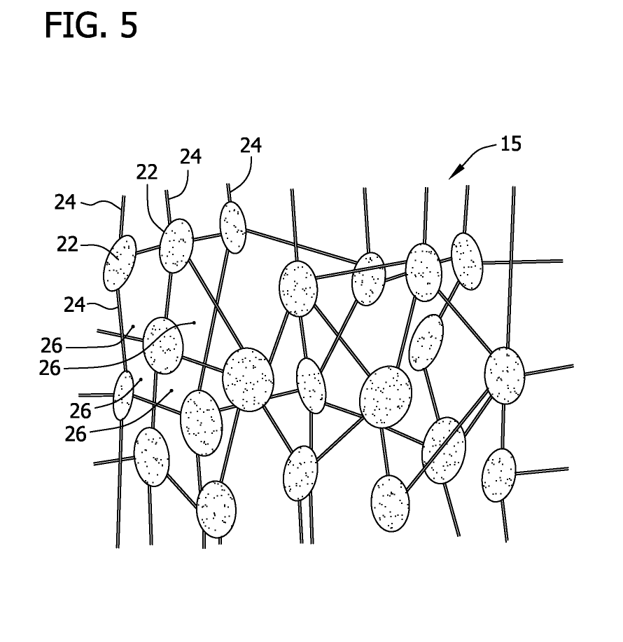

Second layer 14 is a micro-porous membrane that is laminated onto first layer 12. The micro-porous membrane may be made from expanded polyfluorotetraethylene (ePTFE), nylon, polyurethane and/or polypropylene. Also referring to FIG. 5, in an exemplary embodiment, second layer 14 is an ePTFE micro-porous membrane 15. Membrane 15 has a three-dimensional matrix or lattice type structure of a plurality of nodes 22 interconnected by a plurality of fibrils 24. In one exemplary embodiment, membrane 15 is made by extruding a mixture of polytetrafluoroethylene (PTFE) fine powder particles (e.g., available from DuPont of Wilmington, Delaware under the name TEFLON® fine powder resin, and Daikin America, Inc., Orangeburg, N.Y.) and a lubricant. The extrudate is calendared and then “expanded” or stretched in at least one direction to further form fibrils 24 connecting nodes 22 in a three-dimensional matrix or lattice type of structure. “Expanded” is intended to mean sufficiently stretched beyond the elastic limit of the material to introduce permanent set or elongation to fibrils 24.

Membrane 15, in one embodiment, is heated or “sintered” to reduce and minimize residual stress in the ePTFE material. However, in alternate embodiments, membrane 15 is unsintered or partially sintered. Other suitable methods of making a micro-porous membrane 15 include, but are not limited to, foaming, skiving, or casting any of the suitable materials.

Surfaces of nodes 22 and fibrils 24 define numerous interconnecting pores 26 that extend completely through membrane 15 in a tortuous path. In one exemplary embodiment, a suitable average size for pores 26 in membrane 15 is between about 0.01 microns and about 10 microns, and in other embodiments between about 0.1 microns and about 5 microns. Moreover, in other embodiments a suitable average size for pores 26 in membrane 15 is between about 0.1 microns and about 1.0 microns. Further, in other embodiments a suitable average size for pores 26 in membrane 15 is between about 0.15 microns and about 0.5 microns. Although membrane 15 may have any weight, in one embodiment membrane 15 has a weight of about 0.05 to about 1 ounce per square yard, and in another embodiment, from about 0.1 to about 0.5 ounces per square yard.

Third layer 16 is a synthetic nonwoven fabric that is laminated onto second layer 14. Third layer 16 is formed from a plurality of synthetic fibers. The synthetic fibers include at least two different fibers having different melting points. Suitable fiber material include, but not limited to, polyesters, polyamides, polyolefins, thermoplastic polyurethanes, polyethylene teraphthalate (PET), polyetherimides, polyphenyl ethers, polyphenylene sulfides, and polysulfone, aramid. In one embodiment, two different polyester fibers having different melting points are used. For example, a first polyester fiber and a second bicomponent polyester fiber are used. In another embodiment, polyester fibers and polypropylene fibers are used. In yet another embodiment, polyester and polyethylene polymer fibers are used. The synthetic fibers used have an average diameter, in one embodiment, of about 10 microns to about 18 microns, and in another embodiment, about 12 microns to about 16 microns.

Third layer 16 protects the micro-porous membrane of second layer 14 from being directly exposed to any inlet particulates in the inlet air flow stream containing low surface tension hydrocarbon. In one embodiment, at least third layer 16 is coated with a hydrophobic coating and/or an oleophobic coating to aid with mist, fog, agglomerating dust, along with hydrocarbons. The thickness of third layer 16, in one embodiment, is less than 0.08 millimeters (mm), and in another embodiment, about 0.04 mm to about 0.08 mm. To characterize the optimum properties of third layer 16, a transfer function was developed that is referred to as a cover factor. The cover factor is derived from the void volume of third layer 16 and the thickness of third layer 16. Specifically, the cover factor=media void volume ((1−media density in g/cc) (%))×media thickness (mm) The cover factor is applicable for materials with an air permeability of greater than 400 cubic feet per minute (cfm), and suitably for materials with an air permeability of about 600 cfm. A suitable cover factor for third layer 16 is less than 7 mm, and suitably, less than 5 mm. In one embodiment, the cover factor of third layer 16 is about 3 mm to 7 mm, and in another embodiment, about 3 mm to about 5 mm.

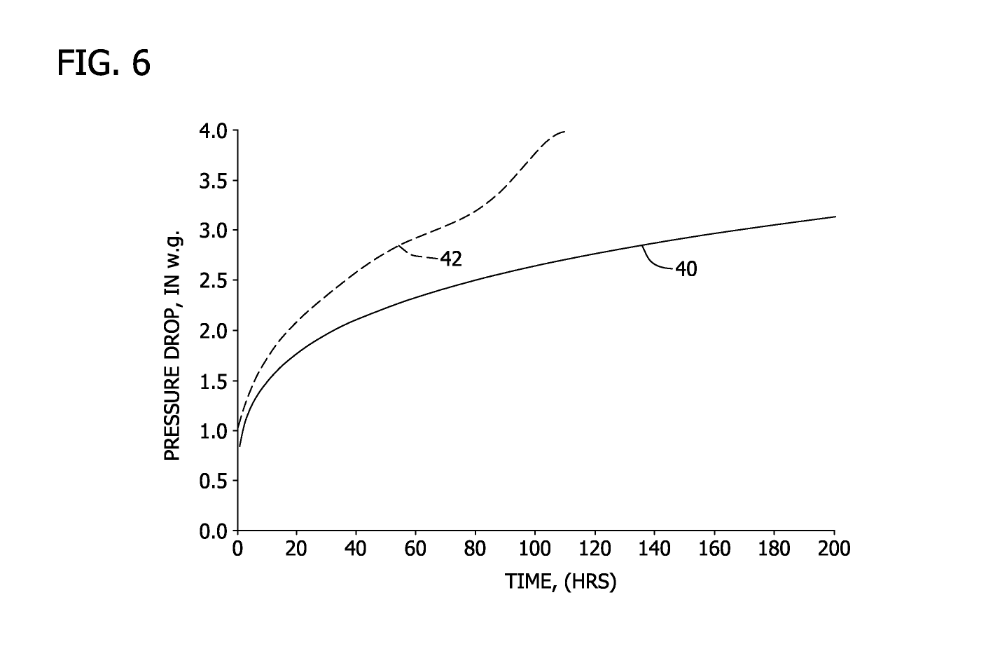

FIG. 6 is a graph of pressure drop versus time (200 hour test) of a filter element that included filter media 10 including third layer 16 with a cover factor of 4 mm compared to a comparison filter element that included a filter media similar to filter media 10 with the exception that the third layer had a cover factor of 14 mm. The 200 hour test procedure is described in the Saudi Aramco Materials System Specification 32-SAMSS-008, titled INLET AIR FILTRATION SYSTEMS FOR COMBUSTION GAS TURBINES, issued May 12, 2008, Appendix II, phase 2. Line 40 represents the pressure drop of the filter element having a cover factor of 4 mm. Line 42 represents the pressure drop of the filter element having a cover factor of 14 mm. The filter element having a cover factor of 4 mm had a pressure drop of about 3.2 inches of water at 200 hours. The filter element having a cover factor of 14 mm had a pressure drop failure after only 110 hours.

Referring also to FIG. 7, in the exemplary embodiment, corrugations 18 are formed as an alternating up and down substantially U-shaped wave in filter media 10. Wave crests 44 and troughs 46 extend in the direction of travel of the web of substrate through the forming equipment. Troughs 46 have an effective depth D of at least 0.02 inch (0.5 mm) to permit cleanability of filter media 10 at high dust loading to maintain low differential pressure, below about 4 inches water column (wc). A corrugation pitch C in the exemplary aspect is about 3 to about 10 corrugations per inch (about 1.2 to about 3.9 corrugations per cm), and in another aspect, from about 3 to about 6 corrugations per inch (about 1.2 to about 2.4 corrugations per cm). The combination of effective depth D and corrugation pitch C permit optimization of touch points of the media with itself which prevents pleat collapse under relatively high static pressure from relatively high air velocities and dust loadings.

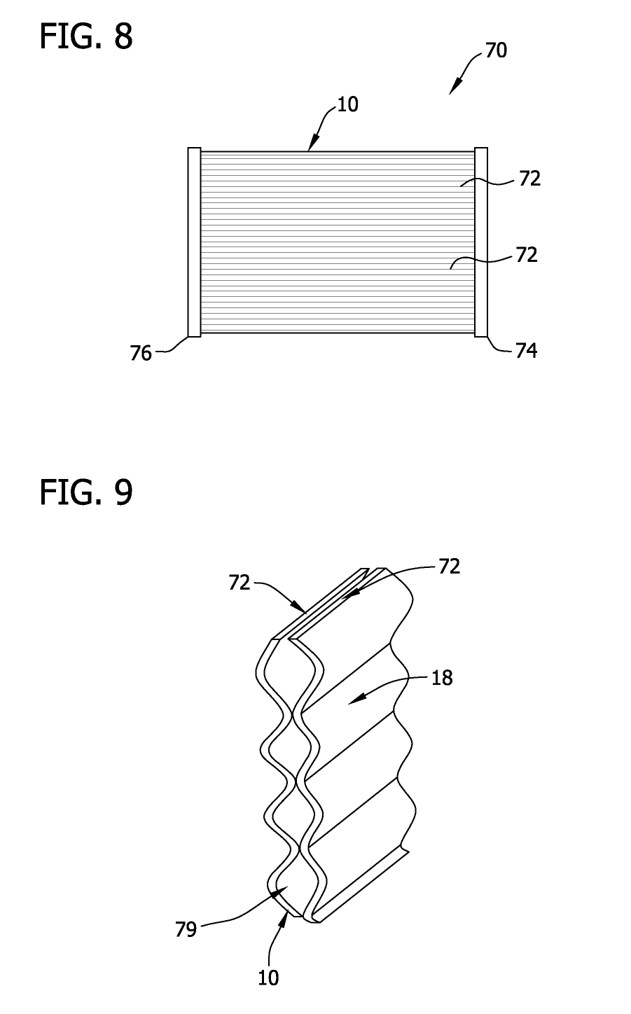

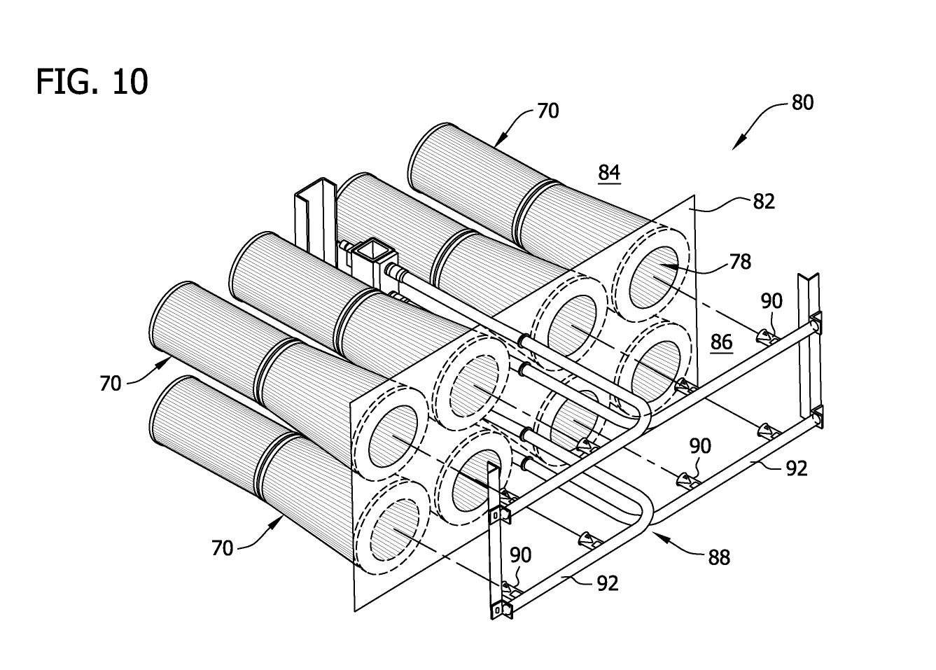

FIG. 8 is a side illustration of a filter element 70 formed from filter media 10. In the exemplary aspect, filter media 10 includes a plurality of pleats 72 arranged so that corrugations 18 act as spacers between pleats 72. Filter element 70 includes a first end cap 74 and an opposing second end cap 76 with filter media 10 extending between end caps 74 and 76. Filter element 70 has a tubular shape with an interior conduit 78 (shown in FIG. 10). Filter element 70 is cylindrical in shape, but can also be frusti-conical as shown in FIG. 10. Filter element 70 can also include an inner and/or an outer support liner to provide structural integrity of filter element 70 and/or support for filter media 10. As shown in FIG. 9, corrugations 18 in adjacent pleats 72 of filter element 70 define oval tubes 79 which permit filtered air to flow through filter element 70. In the exemplary embodiment, corrugations 18 extend substantially perpendicular to the edges of pleats 72.

FIG. 10 is a perspective illustration of a filter assembly 80 that includes a plurality of filter elements 70 mounted to a tube sheet 82 in pairs in an end to end relationship. Tube sheet 82 separates the dirty air side 84 from the clean air side 86 of filter assembly 80. A cleaning system 88 for cleaning filter elements 70 with pulsed air includes a plurality of air nozzles 90 mounted to air supply pipes 92. Pulses of compressed air directed into interior conduit 78 of filter elements 70 are used to clean filter elements 70 of collected dirt and dust.

In an exemplary embodiment, multiple layer filter media 10 may be made by forming first layer 12 from a spunbond nonwoven fabric substrate having a plurality of bicomponent synthetic fibers, and calendering the nonwoven fabric substrate with embossing calender rolls to form a bond area pattern having a plurality of substantially parallel discontinuous lines of bond area to bond the synthetic bicomponent fibers together to form a nonwoven fabric. Then first surface of second layer 14 is laminated onto a surface of first layer 12. Second layer 14 includes a micro-porous membrane 15. Third layer 16 is then laminated onto a second surface of second layer 14. Third layer 16 includes a synthetic nonwoven fabric formed from a plurality of synthetic fibers. The synthetic fibers include at least two different synthetic fibers having different melting points. Third layer has a thickness of less than 0.076 mm, and a cover factor of less than 7 mm. Filter media 10 is then corrugated, and pleated.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A multiple layer HEPA filter media comprising:
a first layer comprising a nonwoven synthetic fabric formed from a plurality of bicomponent synthetic fibers with a spunbond process, and having a bond area pattern comprising a plurality of substantially parallel discontinuous lines of bond area;
a second layer laminated onto said first layer, said second layer comprising a micro-porous membrane; and
a third layer laminated onto said second layer, said third layer comprising a synthetic nonwoven fabric formed from a plurality of synthetic fibers, said synthetic fibers comprising at least two different synthetic fibers having different melting points, said third layer having a cover factor of less than seven millimeters;
said multiple layer filter media further comprising a plurality of corrugations.

2. The filter media in accordance with claim 1, wherein said multiple layer filter media further comprises a plurality of pleats.

3. The filter media in accordance with claim 1, wherein said nonwoven synthetic fabric of said first layer comprises a bond area of about 10% to about 14% of an area of said nonwoven fabric mat.

4. The filter media in accordance with claim 1, wherein said plurality of corrugations comprise a plurality of alternating peaks and valleys extending a length of said filter media, said filter media comprises a corrugation pitch of about 3 to about 10 corrugations per inch and an effective depth of at least 0.02 inch.

5. The filter media in accordance with claim 1, wherein said micro-porous membrane comprises at least one of expanded polytetrafluoroethylene, nylon, polyurethane, and polypropylene.

6. The filter media in accordance with claim 1, wherein said synthetic fibers of said third layer comprise an average diameter of about 10 microns to about 18 microns.

7. The filter media in accordance with claim 1, wherein said third layer has a thickness of less than 0.08 millimeters.

8. The filter media in accordance with claim 1, wherein said third layer has a thickness of about 0.04 millimeters to 0.08 millimeters.

9. The filter media in accordance with claim 1, wherein said two different synthetic fibers of said third layer are selected from the group consisting of a first polyester, a second polyester having a melting point different than said first polyester, and polypropylene.

10. The filter media in accordance with claim 1, further comprising at least one of a hydrophobic coating and an oleophobic coating applied to said third layer.

11. A HEPA filter element comprising:
a first end cap;
a second end cap; and
a multiple layer filter media extending between said first end cap and said second end cap, said filter media comprising:
a first layer comprising a nonwoven synthetic fabric formed from a plurality of bicomponent synthetic fibers with a spunbond process, and having a bond area pattern comprising a plurality of substantially parallel discontinuous lines of bond area;
a second layer laminated onto said first layer, said second layer comprising a micro-porous membrane; and
a third layer laminated onto said second layer, said third layer comprising a synthetic nonwoven fabric formed from a plurality of synthetic fibers, said synthetic fibers comprising at least two different synthetic fibers having different melting points, said third layer having a cover factor of less than seven millimeters;
said multiple layer filter media further comprising a plurality of corrugations.

12. The filter element in accordance with claim 11, wherein said multiple layer filter media further comprises a plurality of pleats.

13. The filter element in accordance with claim 11, wherein said plurality of corrugations comprise a plurality of alternating peaks and valleys extending a length of said filter media, said filter media comprises a corrugation pitch of about 3 to about 10 corrugations per inch and an effective depth of at least 0.02 inch.

14. The filter element in accordance with claim 11, wherein said micro-porous membrane comprises at least one of expanded polytetrafluoroethylene, nylon, polyurethane, and polypropylene.

15. The filter element in accordance with claim 11, wherein said synthetic fibers of said third layer comprise an average diameter of about 10 microns to about 18 microns.

16. The filter element in accordance with claim 11, wherein said third layer has a thickness of less than 0.08 millimeters.

17. The filter element in accordance with claim 11, wherein said two different synthetic fibers of said third layer are selected from the group consisting of a first polyester, a second polyester having a melting point different than said first polyester, and polypropylene.

18. The filter element in accordance with claim 11, further comprising at least one of a hydrophobic coating and an oleophobic coating applied to said third layer.

19. A method of making a multiple layer HEPA filter media, said method comprising:
forming a first layer comprising a spunbond nonwoven fabric substrate comprising a plurality of bicomponent synthetic fibers;
calendering the nonwoven fabric substrate with embossing calender rolls to form a bond area pattern comprising a plurality of substantially parallel discontinuous lines of bond area to bond the synthetic bicomponent fibers together to form a nonwoven fabric;
laminating a first side of a second layer to a surface of the first layer, the second layer comprising a micro-porous membrane;
laminating a third layer to a second side of the second layer, the third layer comprising a synthetic nonwoven fabric formed from a plurality of synthetic fibers, the synthetic fibers comprising at least two different synthetic fibers having different melting points, the third layer having a thickness of less than 0.08 mm, and a cover factor of less than seven millimeters;
corrugating the composite filter media; and
pleating the composite filter media.

20. The method in accordance with claim 19, further comprising applying at least one of a hydrophobic coating and an oleophobic coating to the third layer.
